(19) United States
(12) Patent Application Publication
(10) Pub. No.: US 2025/0208043 A1
(43) Pub. Date: Jun. 26, 2025

(54) Illumination Apparatus for Illuminating a Microfluidic Device, Analyzer Having an Illumination Apparatus, and Method for Illuminating a Microfluidic Device

(71) Applicant: Robert Bosch GmbH, Stuttgart (DE)

(72) Inventors: Reinhold Fiess, Durbach (DE); Ingo Ramsteiner, Ettlingen (DE)

(21) Appl. No.: 18/848,874

(22) PCT Filed: Mar. 10, 2023
(86) PCT No.: PCT/EP2023/056192

§ 371 Date: Sep. 19, 2024

(30) Foreign Application Priority Data
Mar. 24, 2022 (DE) 10 2022 202 863.5

(51) Int. Cl. G01N 21/64

(52) U.S. Cl. CPC G01N 21/645; G01N 2021/6463

(57) ABSTRACT

An illumination apparatus is for illuminating a microfluidic device arranged in a receiving region of an analyzer. The illumination apparatus includes a fluorescent layer arranged on a carrier element with at least one fluorescent region configured to emit a fluorescent light beam excited by an excitation light beam. The carrier element is designed to be transparent to the wavelength of the fluorescent light beam. The illumination apparatus further includes an optical layer arranged on a side of the carrier element opposite the fluorescent layer with at least one optical area configured to convert the fluorescent light beam into a focused focusing beam and to direct the focusing beam to a target area of the microfluidic device.

### PRIOR ART

The invention proceeds from an illumination apparatus, an analyzer having an illumination apparatus, and a method for illuminating according to the preamble of the independent claims.

To analyze sample material, so-called lab-on-chip cartridges comprising a sample can be inserted into analyzers and be processed. For example, a molecular diagnostic assay can be arranged on a plastic cartridge with a microfluidic network. The analyzer can be designed to process such cartridges, i.e., it can control microfluidic processes on the cartridge and, e.g., heat or illuminate certain regions.

### DISCLOSURE OF THE INVENTION

In light of this, with the approach presented herein, an illumination apparatus, an analyzer with an illumination apparatus, and a method of illuminating according to the main claims are presented. Advantageous embodiments of and improvements to the apparatus specified in the independent claim are made possible by the measures presented in the dependent claims.

With the illumination apparatus presented herein, it is advantageously possible to illuminate one or more contiguous surfaces with light, for example on a lab-on-chip cartridge. The number, shape, and size of the surfaces can be freely selectable within a certain range and can be flexibly controllable electronically. The light itself may advantageously meet the requirements for fluorescence excitation of molecular diagnostic assays, also with multiple color channels. This means a spectrum that is precisely defined in terms of center wavelength and width, or a plurality of such spectra, between which switching is possible.

An illumination apparatus for illuminating a microfluidic device arranged in a receiving region of an analyzer is proposed. The illumination apparatus comprises a fluorescent layer arranged on a carrier element with at least one fluorescent region, which is configured to emit a fluorescent light beam excited by an excitation light beam, wherein the carrier element is designed to be transparent to the wavelength of the fluorescent light beam. In addition, the illumination apparatus comprises an optical layer arranged on a side of the carrier element opposite the fluorescent layer and having at least one optical area configured to convert the fluorescent light beam into a focused focusing beam and direct the focusing beam to a target area of the microfluidic device.

For example, the analyzer can be a device for performing diagnostic tests, such as rapid PCR tests. A sample, which can, e.g., be a liquid comprising sample material or a solid sample, can be introduced into a suitable microfluidic device, by way of example, which can, e.g., be a lab-on-chip cartridge comprising a microfluidic network for processing the sample. The microfluidic device with the sample can, e.g., be manually introduced into the analyzer's receiving region to be processed within the analyzer. In this case, the sample can be excited by lighting the same by means of the illumination apparatus described herein, which can also be referred to as a phosphor screen. The illumination apparatus presented herein can advantageously be used to illuminate one or more surfaces on a lab-on-chip cartridge. The light used to illuminate may meet the requirements for fluorescence excitation of molecular diagnostic assays. Many molecular diagnostic methods, such as polymerase chain reactions (PCR), are based on fluorescence measurements from a metrological point of view. The indirect generation of light by means of fluorescent or phosphorescent materials may be necessary. This may advantageously be made possible by means of the fluorescent layer of the illumination apparatus presented herein. The illumination apparatus, which may also be referred to as a phosphor screen, comprises a carrier element made of a transparent substrate, which may be coated on one side with one or various fluorescent phosphors. For historical reasons, these may be referred to as phosphors, but this has nothing to do with the chemical element of the same name. They may include several classes of materials and meta-materials such as doped inorganic crystalline or amorphous substances, organic substances, or quantum dots. Generally, they can be characterized by being able to absorb light of one wavelength and thereby emit excited fluorescent radiation. Various known principles may be employed to provide the excitation light beam to excite the fluorescent region of the fluorescent layer, for example a so-called flying spot scanner, which can direct a light beam using a micromechanical mirror. Thus, if the projector directs excitation light, preferably bundled, to a phosphor coated point of the screen, the phosphor can emit fluorescent radiation at this point. This can initially spread in all spatial directions and penetrate the carrier element, which is formed from a substrate that is transparent for the respective relevant wavelengths, which means above all that can have transparency in the area of phosphor-converted radiation. In principle, for example, a glass pane may be suitable as a substrate. Due to the transparency of the carrier element, a fluorescent light beam provided by the fluorescent layer can be passed through the carrier element to the optical layer arranged on the side of the carrier element opposite the fluorescent layer. The optical layer is now configured to collect the light and radiate it in a specific spatial direction, according to the invention, onto a surface to be illuminated with the generated light, that is to say, a target area of the microfluidic device. For this purpose, the optical layer can be configured with optical elements, for example, which can be suitable to direct the light generated in the phosphor layer in a desired direction. For example, the optical layer may comprise holographic optical elements (HOE), more preferably volume holograms or transmission holograms, which may be introduced into, for example, a suitable polymer layer. However, surface holograms or diffractive elements may alternatively be used. These elements may be shaped to collect light from a point of the opposing phosphor of a particular wavelength and radiate bundled in the desired spatial direction. Advantageously, radiation generated by fluorescence can thereby be directed specifically to a region of the microfluidic device at which a reaction to be performed at the relevant wavelength can be particularly advantageous during an analysis process.

According to one embodiment, the optical layer can be configured to allow the excitation light beam to pass through unfocused. For example, when providing the excitation light beam from the optical layer, the optical layer can initially remain ineffective, since it can only be configured to focus the wavelengths of the phosphoric emissions, not the excitation light. However, the fluorescent light beam may then be further collected by the optical layer and directed further to the target area. This has the advantage that the lighting device can be illuminated from two different sides and can thus be variably used. According to one embodiment, the optical layer may be configured to focus the excitation light beam on the fluorescent region. For example, the optical layer may be configured to focus light of a first wavelength (that of the excitation light) on the fluorescent region of the fluorescent layer while simultaneously collecting and directing light of a different wavelength (that of the fluorescent light) in a desired direction. For this purpose, the optical layer can be configured, for example with a multiplex HOE or a second HOE, arranged layer-by-layer over the first, whereby the excitation light can be influenced. Thus, advantageously, the excitation light can be focused on the phosphor on the one hand or the focus can be improved by this, and on the other hand, the phosphor-converted light can be optimally directed further to the target surface.

According to one embodiment, the optical layer can be formed with at least one holographic optical element. Such a holographic optical element (HOE) may, for example, have a multiplex hologram or multiple single holograms layered on top of each other. The intrinsic wavelength selectivity of holographic or diffractive structures is an advantage in the application according to the invention because it narrowly defines the wavelength range of the light illuminated by the cartridge. Undesirable wavelengths caused by phosphor, glass or by scattered light are not deflected by the HOE and do not get onto the cartridge, or do so only in very small proportions. As an alternative to volume holograms, surface holograms may also be used, for example. If a suitable substrate is used, for example a plastic such as polycarbonate or polymethyl methacrylate, these could also be embossed directly into the substrate. This is also possible with diffractive optical elements.

According to one embodiment, the fluorescent layer may be designed to emit the fluorescent light beam in a narrow band. A narrow band is preferably a spectral half-width of less than 100 nanometers (nm), preferably less than 50 nm, more preferably less than 30 nm, for example 40 or 20 nm. For example, the fluorescent layer may comprise particularly narrow band emitting material and metamaterial classes or quantum points, such as SrGa2S4:Eu2+ (emission at 540 nm, FWHM approximately 45 nm) or Ba0.8Sr0.2Mg3SiN4:Eu (emission at 635 nm, FWHM approximately 45 nm). This is particularly advantageous if the respective phosphor is used only for one excitation channel and is changed for other channels.

According to one embodiment, the fluorescent layer may comprise a first fluorescent region for emitting a first fluorescent light beam in a first wavelength and at least one further fluorescent region for emitting a further fluorescent light beam in a further wavelength. For example, different areas of the fluorescent layer may be formed with different phosphors. Each position on the illumination apparatus can thus be associated with a particular fluorescent region which can determine the wavelength of the generated fluorescent light. The individual areas can be distributed in a manner similar to a chess board or honeycomb, for example. This has the advantage that the illumination apparatus can be used for a plurality of different reaction processes in which different wavelengths can be required.

In addition, the optical layer may comprise at least a first optical area for converting the first fluorescent light beam to a first focusing beam and a further optical area for converting the further fluorescent light beam to a further focusing beam. For this purpose, the optical areas may comprise in particular HOEs. For example, each fluorescent region on the fluorescent layer may be associated with an optical region on the optical layer. Thus, as described above, in particular, different phosphors may be contained in the fluorescent regions, each of which is associated with an HOE from an optical area. Depending on which fluorescent region is excited by the excitation light beam, the relevant optical region may collect this fluorescent light and direct it to a desired point on the microfluidic device. As a result, the light beam is, on the one hand, able to be advantageously reduced to an optimum wavelength in order to analyze a sample and, on the other hand, the beam direction is also able to be directed as precisely as possible to the target region where the sample is arranged.

According to one embodiment, the optical layer can be configured to direct the first focusing beam onto a first target area and the further focusing beam onto a further target area of the microfluidic device. For example, different optical areas of the optical layer may be configured to direct the focusing beam of light to respective different target areas of the microfluidic device. Stated another way, for each position on the target surface, a surface of each phosphor can be available on the phosphor screen, the light of which can then be directed to that same target position. This advantageously allows an intensity distribution that can be defined by controlling the projector with all available wavelengths.

According to one embodiment, the optical layer may be configured to direct the first focusing beam and the further focusing beam to a first target area of the microfluidic device. For example, the entire illumination apparatus may be used to illuminate a common point or area of the microfluidic device. In this case, a targeted excitation light beam can only be used to control which wavelength is currently employed, in that it can selectively stimulate only the surfaces of one phosphor type. This may be advantageous when it is desired to use a large total phosphor surface area to distribute the radiation load.

According to one embodiment, the illumination apparatus may comprise a primary light source, which may be designed to emit the excitation radiation to excite the fluorescent layer For example, the primary light source may be configured as a laser projector and may comprise, for example, a laser diode, a lens, and a movable mirror. Preferably, it may be a flying spot scanner, however other types (DLP, LCOS) are conceivable. Advantageously, the light source may direct the excitation light beam to selected areas of the fluorescent layer.

In addition, the light source may be arranged on the side of the optical layer and additionally or alternatively on the side of the fluorescent layer. Advantageously, a design of the lighting device can be varied according to the conditions at the site of use and can be constructed more compactly, for example.

Also presented is an analyzer for analyzing a sample in a microfluidic device, wherein the analyzer comprises a receiving region for receiving the microfluidic device and a variant of the illumination apparatus presented hereinabove. For example, the analyzer may be designed for the integration of a molecular diagnostic assay on a plastic cartridge with a microfluidic network. The actual device may be designed to process such cartridges, i.e., it can, for example, control microfluidic processes on the cartridge and heat and, additionally or alternatively, illuminate certain regions. For example, the analyzer may include a camera with replaceable bandpass filters that may view a particular region of the cartridge. Advantageously, these regions can be illuminated with the illumination apparatus, for example with light of a defined wavelength range, in order to excite fluorescence there, which can be evaluated diagnostically.

In addition, a method for illuminating a microfluidic device arranged in a receiving region of an analyzer is presented, wherein the method comprises a step of emitting a fluorescent light beam in response to an excitation light beam, a step of converting the fluorescent light beam into a focusing light beam, and a step of directing the focusing light beam to a target area of the microfluidic device.

For example, this method can be implemented in software or hardware, or in a mixed form of software and hardware, for example in a control device.

Exemplary embodiments of the approach presented herein are shown in the drawings and explained in greater detail in the following description. The figures shows:

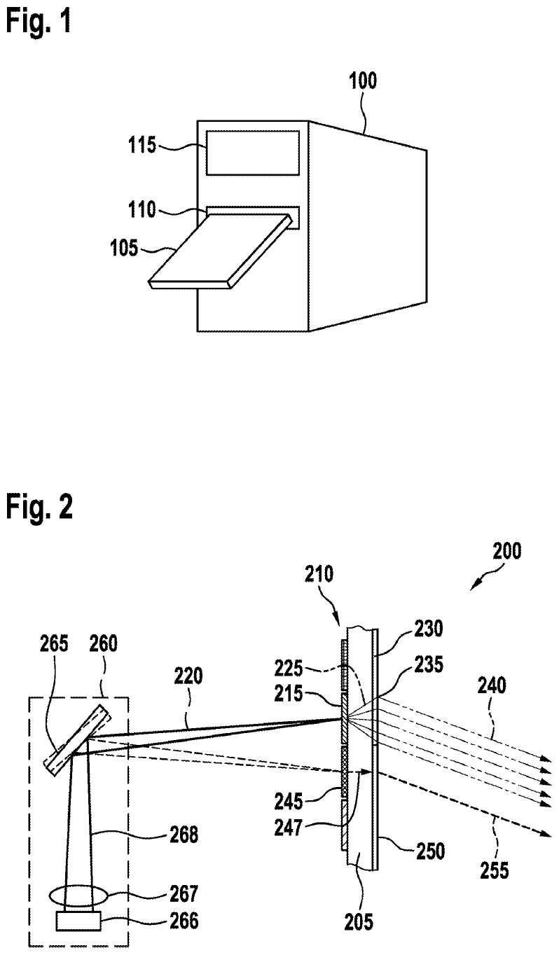

FIG. 1 a schematic representation of an exemplary embodiment of an analyzer;

FIG. 2 a schematic representation of an illumination apparatus according to an exemplary embodiment;

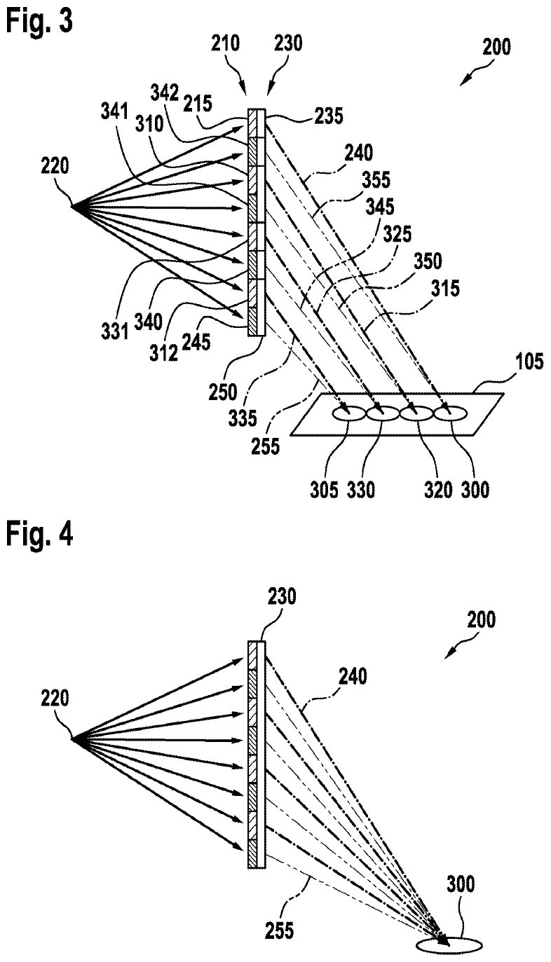

FIG. 3 a schematic representation of an illumination apparatus according to an exemplary embodiment;

FIG. 4 a schematic representation of an illumination apparatus according to an exemplary embodiment;

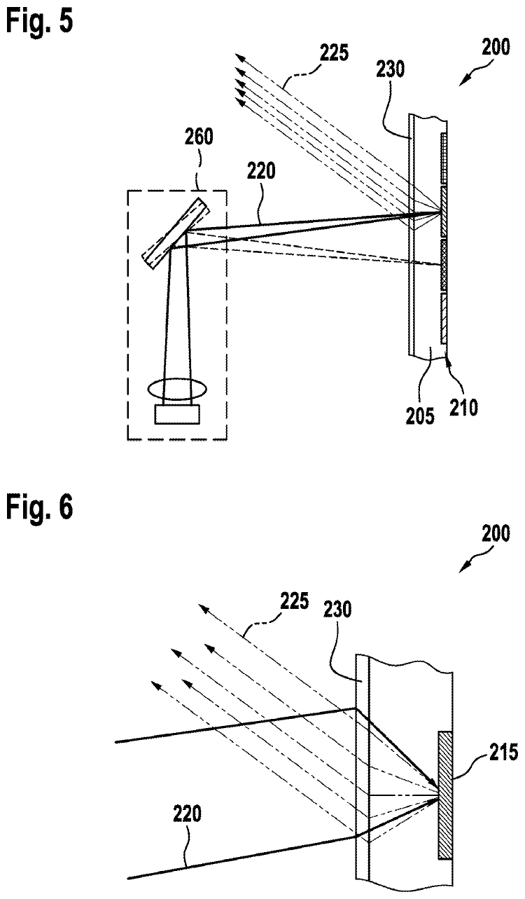

FIG. 5 a schematic representation of an illumination apparatus according to an exemplary embodiment;

FIG. 6 a schematic representation of an illumination apparatus according to an exemplary embodiment; and

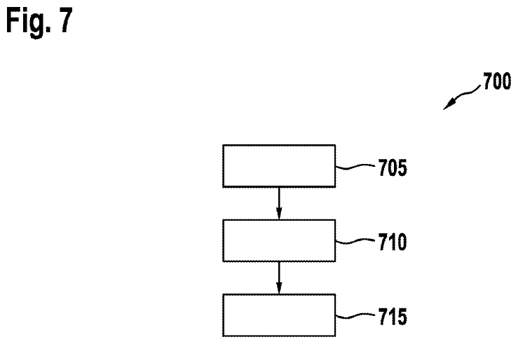

FIG. 7 a flow diagram of a method for illuminating a microfluidic device arranged in a receiving region of an analyzer according to an exemplary embodiment.

In the following description of advantageous exemplary embodiments of the present invention, identical or similar reference signs are used for elements shown in the various drawings having a similar function, wherein a repeated description of these elements has been omitted.

FIG. 1 shows a schematic representation of an exemplary embodiment of an analyzer 100. In this exemplary embodiment, the analyzer 100 is designed to analyze samples that have been introduced, as a result of which it is possible, for example, to perform PCR tests. For this purpose, a microfluidic device 105, which, merely by way of example, is a cartridge with a plastic housing and a microfluidic network for processing the sample, can be inserted into a receiving region 110. In this exemplary embodiment, the analyzer further comprises a display 115 with a touch function, by means of which settings for the desired analysis process can be entered manually (by way of example only). The display 115 is, by way of example only, also designed to display analysis results.

In other words, the concept of the analyzer provides for the integration of a molecular diagnostic assay on a plastic cartridge with a microfluidic network. The actual device is designed to process such cartridges, i.e., it can control microfluidic processes on the cartridge and heat and additionally or alternatively illuminate certain regions. In particular, in this exemplary embodiment it comprises an illumination apparatus, as described in more detail in Figures through 2 and 4 below, which can excite and evaluate fluorescence signals. By way of example, this unit consists of two parts. Firstly, a camera with interchangeable bandpass filters that views a specific region of the cartridge. Secondly, a device that is designed to illuminate certain regions of the cartridge with light of a defined wavelength range in order to excite fluorescence there. These regions are arranged in the camera's field of view.

FIG. 2 shows a schematic representation of an illumination apparatus 200 according to an exemplary embodiment. The illumination apparatus 200 is designed to illuminate a microfluidic device in a receiving region of an analyzer as described in the foregoing figure. The illumination apparatus comprises a carrier element 205, which in an exemplary embodiment is a transparent glass sheet. A fluorescent layer 210 with a fluorescent region 215 is arranged on the carrier element 205 and is configured to emit a fluorescent light beam 225 excited by an excitation light beam 220, wherein the carrier element 205 is configured transparently for the wavelength of the fluorescent light beam 225. In addition, the illumination apparatus 200 comprises an optical layer 230 arranged on a side of the carrier element 205 opposite the fluorescent layer 210, with an optical area 235 configured to convert the fluorescent light beam 225 to a focused focusing light beam 240 and direct the focusing light beam 240 to a target area of the microfluidic device. To this end, the optical area 235 can preferably comprise a correspondingly configured HOE.

In an exemplary embodiment, the fluorescent region 215 of the fluorescent layer 210 is configured to emit the fluorescent light beam 225 at a first wavelength. In addition, in an exemplary embodiment, the fluorescent layer 210 of the illuminating device 200 comprises a further fluorescent region 245 for emitting a further fluorescent light beam 247 at a further wavelength. Just as the optical area 235 is configured to convert the fluorescent light beam 225 to a focus beam 240, only by way of example is a further optical area 250 of the optical layer 230 configured to convert the further fluorescent light beam 247 to a further focus beam 255. For this purpose, the optical area 235 and the further optical area 250 are arranged, by way of example, directly opposite the fluorescent area 215 and the further fluorescent area 245 on the carrier element 205 and preferably comprise holographic optical elements (HOE) configured accordingly.

In other words, the illumination apparatus 200, which may also be referred to as a phosphor screen, comprises a transparent substrate for the respective relevant wavelengths. This primarily means transparency in the area of the fluorescent light beam 225 or the phosphor converted radiation. The stated substrate is coated on one side with one or more phosphors. For historical reasons, these are also referred to as phosphors in specialist circles, but this has nothing to do with the chemical element of the same name. In an exemplary embodiment, they comprise several classes of materials and meta-materials, for example doped inorganic crystalline or amorphous substances, organic substances or quantum dots. Generally, they are characterized by being able to absorb light of one wavelength, thereby emitting excited fluorescent radiation. On the side facing away from the phosphors, the substrate is provided with optical elements which are suitable to direct the light generated in the phosphor layer in a desired direction. In an exemplary embodiment, such optical elements of the optical layer 230 are holographic optical elements (HOE) as described above, such as volume holograms, merely by way of example. In another exemplary embodiment, the optical layer may comprise transmission holograms, which may preferably be introduced into a suitable polymeric layer. Alternatively, surface holograms or diffractive elements may also be employed. These elements or the optical area 235 are arranged to collect light from a point of the opposing fluorescent region 215 at a particular wavelength and radiate it in a bundle in a particular spatial direction.

In an exemplary embodiment, the illumination apparatus 200 also comprises a primary light source 260 configured to emit the excitation light beam 220 to excite the fluorescent layer 210. The light source 260 is arranged, only by way of example, on the side of the fluorescent layer 210, which in turn is configured in an exemplary embodiment to emit the fluorescent light beam 225 as well as the further fluorescent light beam 247 in a narrow band excitedly by the excitation light beam 220. Various principles can be employed to project the excitation light beam 220, but the preferred principle is a flying spot scanner that directs a beam of light using a micromechanical mirror 265. The array of laser diode 266, lens 267 and mirror 265 shown in this figure, as well as the outlined beam path of laser light 268, are representative of such a laser projector. This provides, among other things, the possibility for the projector to direct the excitation light beam 220 to selected areas of the fluorescent layer 210. Instead of a single micromechanical mirror, multiple mirrors may also be employed, for example two single-axis mirrors. In other exemplary embodiments, other types, such as DLP or LCOS, may also be employed as the primary light source. Thus, if the light source 260 directs the excitation light beam 220, bundled by way of example only, onto the fluorescent region 215, then the phosphor emits fluorescent radiation at this point. This initially spreads in all spatial directions. The HOE on the other side of the carrier element 205 are now configured to collect the light and radiate it in a particular spatial direction, by way of example on a surface to be illuminated with the generated light. The intrinsic wavelength selectivity of holographic or diffractive structures is an advantage in the application according to the invention because it narrowly defines the wavelength range of the light illuminated by the cartridge. Unwanted wavelengths caused by phosphor, glass or by scattered light cannot be directed by the HOE and do not reach the cartridge, or do so only in very small proportions.

FIG. 3 shows a schematic representation of an illumination apparatus 200 according to an exemplary embodiment. The illumination apparatus 200 shown here corresponds to or is similar to the illumination apparatus described in the preceding FIG. 2. The illumination apparatus 200 comprises a carrier element 205, that is, a transparent substrate coated on one side with the fluorescent layer 210 and on the other side comprising the optical layer 230, which in this exemplary embodiment is an array of holographically optical elements (HOE). In this exemplary embodiment, the fluorescent layer 210 comprises a first fluorescent region 215, which corresponds, by way of example, to the fluorescent region described in the preceding FIG. 2, and which is configured to emit a first fluorescent light beam at a first wavelength. Furthermore, the fluorescent layer 210 comprises a further fluorescent region 245 for emitting a further fluorescent light beam at a further wavelength different from the first wavelength. The first fluorescent light beam can be converted from a first optical area 235 corresponding to the optical area described in the previous FIG. 2 in this exemplary embodiment to a first focusing beam 240, which further has the exemplary first wavelength λ₁. The first focusing beam 240 can be directed, only by way of example, to a first target region 300 of the microfluidic device 105. The further optical area 250 is configured in this exemplary embodiment to convert the further fluorescent light beam into a further focusing beam 255, which furthermore has the exemplary further wavelength λ₂. The further focusing beam 255 can be directed, only by way of example, to a further target area 305 of the microfluidic device 105, which is located away from the first target area 300.

In an exemplary embodiment, the fluorescent layer 210 also has, by way of example, a second first fluorescent region 310, a third first fluorescent region 331, and a fourth first fluorescent region 312, wherein all first fluorescent regions 215, 310, 331, 312 are configured to emit fluorescent light at a first wavelength λ₁. The optical layer 230 is configured to convert the first fluorescent light beam to a first focusing beam 225 and direct it to the first target region 300. Similarly, in an exemplary embodiment, a second first fluorescent light beam of the second first fluorescent region 310 can be converted to a second first focusing beam 315 and directed to a second target region 320. Similarly, in an exemplary embodiment, a third first fluorescent light beam of the third first fluorescent region 331 can be converted to a third first focusing beam 325 and directed to a third target region 330. Similarly, in an exemplary embodiment, a fourth first fluorescent light beam of the fourth first fluorescent region 312 can be converted to a fourth first focusing beam 335 and directed to the further target region 305.

In an exemplary embodiment, the fluorescent layer 210 also has for example a second further fluorescent area 340, a third further fluorescent area 341 and a fourth further fluorescent area 342, wherein all further fluorescent areas 245, 340, 341, 342 are configured to emit fluorescent light at a second wavelength λ₂. The optical layer 230 is configured to convert the further fluorescent light beam into a further focusing beam 255 and direct it to the further target area 305. Similarly, in an exemplary embodiment, a second further fluorescent light beam of the second further fluorescent region 340 can be converted to a second further focusing beam 345 and directed to the third target region 330. Similarly, in an exemplary embodiment, a third further fluorescent light beam of the third further fluorescent region 341 can be converted to a third further focusing beam 350 and directed to the second target region 320. Similarly, in an exemplary embodiment, a fourth further fluorescent light beam of the fourth further fluorescent region 342 can be converted to a fourth further focusing beam 355 and directed to the first target region 300.

In other words, in an exemplary embodiment, each position on the target surface is provided with a surface of each phosphor on the phosphor screen, the light of which can then be directed to precisely this target position. The phosphor surfaces determine the wavelengths and the HOEs determine the directions in this case. Both are independently adjustable in one exemplary embodiment. This allows for an intensity distribution that can be defined by controlling the projector with all available wavelengths.

FIG. 4 shows a schematic representation of an illumination apparatus 200 according to an exemplary embodiment. The illumination apparatus 200 shown here corresponds to or is similar to the illumination apparatus described in the preceding FIGS. 2 and 3. In this exemplary embodiment, the optical layer 230 is configured to direct the first focusing beam 240 and the further focusing beam 255 to the first target area 300 of the microfluidic device. Accordingly, in this exemplary embodiment, the entire illumination apparatus 200 can be used to illuminate a common point or area of the target surface. That is to say that it is possible, by way of example only, to allow all regions of the phosphor screen or the screen to radiate onto one target. A light source for providing an excitation light beam 220 controls, only by way of example, which wavelength is to be used at any given time by selectively exciting only the surfaces of one phosphor type. This makes it possible to distribute the radiation load when using a large overall phosphor surface.

FIG. 5 shows a schematic representation of an illumination apparatus 200 according to an exemplary embodiment. The illumination apparatus 200 shown here corresponds to or is similar to the device described in the preceding FIGS. 2, 3 and 4. In this exemplary embodiment, the illumination apparatus 200 comprises a primary light source 260 configured to emit the excitation light beam 220 to excite the fluorescent layer 210. The light source 260 is arranged, only by way of example, on the side of the optical layer 230. The optical layer 230, which may also be referred to as a holographic layer, is configured in this exemplary embodiment to allow the excitation light beam 220 to pass unfocused. Stated another way, the shield can be illuminated from the HOE side in this exemplary embodiment, wherein the holographic optical elements of the optical layer 230 remain initially ineffective, since in this exemplary embodiment they are configured for the wavelengths of the phosphor emissions, not that of the excitation light. However, as in the exemplary embodiments described in the previous FIGS. 2, 3 and 4, the phosphor-converted light, i.e. the fluorescent light beam 225, can be collected and directed by the HOE. The transparency of the substrate of the carrier element 205 is also important for the excitation wavelength in this exemplary embodiment, but technically unproblematic.

FIG. 6 shows a schematic representation of an illumination apparatus 200 according to an exemplary embodiment. The illumination apparatus 200 shown here corresponds to or is similar to the illumination apparatus described in the preceding FIGS. 2, 3, 4 and 5. In addition, in the assembly described in the previous FIG. 5, the excitation light beam 220 is provided by the optical layer 230 concurrently, as it is in the exemplary embodiment shown here. Additionally, in this exemplary embodiment, the optical layer 230 is configured to focus the excitation light beam 220 onto the fluorescent region 215. This is possible, only by way of example, by designing the optical layer 230 with a multiplex HOE. The multiplex HOE is designed, only by way of example, to focus light of a first wavelength (that of the excitation light beam) on the phosphor and simultaneously collect and direct light of a different wavelength (that of the phosphor-converted light) in a desired direction. In another exemplary embodiment, focusing the excitation light on a particular fluorescent area of the fluorescent layer may also be influenced, for example, by using a second HOE arranged layer-by-layer over the first HOE. Thus, in this exemplary embodiment, the excitation light beam can only be focused on the phosphor and the phosphor converted light can only be directed to a target surface by an exemplary HOE.

FIG. 7 shows a flow diagram of a method 700 for illuminating a microfluidic device arranged in a receiving region of an analyzer according to an exemplary embodiment. Furthermore, the method 700 comprises a step 705 of emitting a fluorescent light beam according to an excitation radiation, a step 710 of converting the fluorescent light beam into a focused focusing light beam and a step 715 of directing the focusing light beam to a target area of the microfluidic device. Method 700 can be used for illumination with light of one or more adjacent surfaces, for example on a lab-on-chip cartridge. The number, shape, and size of the surfaces can be freely selected within a certain range and can be flexibly controlled electronically. The light itself meets the requirements for the fluorescence excitation of molecular diagnostic assays, ideally also with multiple color channels. This means a spectrum that is precisely defined in terms of center wavelength and width, or a plurality of such spectra, between which switching is possible.

1. An illumination apparatus for illuminating a microfluidic device arranged in a receiving area of an analyzer, the illumination apparatus comprising:
a carrier element;
a fluorescent layer arranged on the carrier element, the fluorescent layer having at least one fluorescent region, the at least one fluorescent region configured to emit at least one fluorescent light beam excited by an excitation light beam, wherein the carrier element is configured to be transparent to a wavelength of the at least one fluorescent light beam; and
an optical layer arranged on a side of the carrier element opposite the fluorescent layer, the optical layer having at least one optical area, the at least one optical area configured to convert the at least one fluorescent light beam to at least one focused focusing beam and to direct the at least one focusing beam to at least one target area of the microfluidic device.

2. The illumination apparatus according to claim 1, wherein the optical layer is configured to pass the excitation light beam unfocused.

3. The illumination apparatus according to claim 1, wherein the optical layer is configured to focus the excitation light beam onto the at least one fluorescent region.

4. The illumination apparatus according to claim 1, wherein the optical layer is formed with at least one holographic optical element.

5. The illumination apparatus according to claim 1, wherein the fluorescent layer is configured to emit the at least one fluorescent light beam with a spectral half-width less than 100 nm.

6. The illumination apparatus according to claim 1, wherein the at least one fluorescent region comprises a first fluorescent region configured to emit a first fluorescent light beam at a first wavelength and at least one further fluorescent region configured to emit a further fluorescent light beam at a further wavelength.

7. The illumination apparatus according to claim 6, wherein the at least one optical area comprises at least a first optical area configured to convert the first fluorescent light beam to a first focusing beam and a further optical area configured to convert the further fluorescent light beam to a further focusing beam.

8. The illumination apparatus according to claim 7, wherein the optical layer is configured to direct the first focusing beam to a first target area of the at least one target area and the further focusing beam to a further target area of the at least one target area.

9. The illumination apparatus according to claim 7, wherein the optical layer is configured to direct the first focusing beam and the further focusing beam to a first target area of the at least one target area.

10. The illumination apparatus according to claim 1, further comprising:
a primary light source configured to emit the excitation light beam to excite the fluorescent layer.

11. The illumination apparatus according to claim 10, wherein the primary light source is arranged on a side of the optical layer and/or on a side of the fluorescent layer.

12. An analyzer for analyzing a sample in a microfluidic device, the analyzer comprising:
a receiving region configured to receive the microfluidic device; and
the illumination apparatus according to claim 1.

13. A method for illuminating a microfluidic device arranged in a receiving region of an analyzer, the method comprising:
emitting a fluorescent light beam in response to an excitation light beam;
converting the fluorescent light beam into a focused focusing beam; and
directing the focusing beam to a target area of the microfluidic device.
